(19) United States
(12) Patent Application Publication
(10) Pub. No.: US 2008/0320457 A1
(43) Pub. Date: Dec. 25, 2008

(54) Intermediate Code Metrics

(75) Inventors: Todd King, Bothell, WA (US); Michael C. Fanning, Redmond, WA (US); Nachiappan Nagappan, Redmond, WA (US); Marcelo Birnbach, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/765,224

(22) Filed: Jun. 19, 2007

(51) Int. Cl. G06F 9/45

(52) U.S. Cl. 717/146

(57) ABSTRACT

Metrics may be determined from intermediate computer code by reading and analyzing an entire application using intermediate code, including any linked portions. The metrics may include cyclomatic complexity, estimated or actual number of lines of code, depth of inheritance, type coupling, and other metrics. The metrics may be combined into a quantifiable metric for the code.

### BACKGROUND

Intermediate computer code or bytecode is a compiled form of an executable program that may be executed by a virtual machine or other intermediate abstraction between source code and hardware executable code. Intermediate computer code may be created by compiling source code, and in many cases several different compilers may be used to create intermediate code from different computer languages.

When executed, intermediate computer code may be interpreted or compiled again using a just in time or runtime compiler that generates executable code that may be tailored to the hardware on which it is executed. Many different virtual machine environments may be created to operate on different hardware platforms, but may use a common source code and intermediate code.

Software metrics may be used to quantify certain aspects of a set of software. In some cases, metrics may be determined from source code, while in other cases metrics may be determined from instrumented code, which is code that has additional measuring capabilities added to the code. The metrics may quantify many different aspects of the code, including complexity, length, and other factors.

### SUMMARY

Metrics may be determined from intermediate computer code by reading and analyzing an entire application using intermediate code, including any linked portions. The metrics may include cyclomatic complexity, estimated or actual number of lines of code, depth of inheritance, class coupling, and other metrics. The metrics may be combined into a quantifiable metric for the code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system for code development and analysis.

FIG. 2 is a diagram of an embodiment showing an analysis mechanism.

FIG. 3 is a flowchart of an embodiment showing a method for analyzing intermediate code.

### DETAILED DESCRIPTION

Code metrics may be derived from intermediate code to give a quantifiable assessment of various factors. The metrics may be derived from a linked version of intermediate code which may include third party code or other code to which source code is not available.

The metrics include cyclomatic or structural complexity which may include a measure of the branching or complexity of the programming logic. Other metrics may include the depth of inheritance for each object as well as the degree to which modules, classes, and class members are coupled in the application.

An estimation of the number of program lines of source code may be made by counting the lines of intermediate code and multiplying a conversion factor. In some instances where source code is available, the number of lines of code may be determined from source code metadata or from directly counting the lines of code from the source code. In other instances, the number of lines of code may be determined from debug symbols associated with compiled binaries, when such symbols are available.

The metrics may be combined into a composite index or some other composite score. Such an index may give some feedback to a developer or other concerned parties of the ease of maintaining or modifying the code or for comparing two different sets of code. In many ways, the metrics may highlight best practices for code development and programming or to identify code which may be at risk for certain problems. Other metrics may also be developed and used to determine quantifiable measures of specific aspects of the code.

In many embodiments, an analysis tool may be operated within or as an accessory to a runtime environment. The analysis tool may analyze actual linked code prior to compiling with a runtime compiler without instrumentation or other additions. After analysis, a reporting function may generate a report or otherwise output various statistics.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

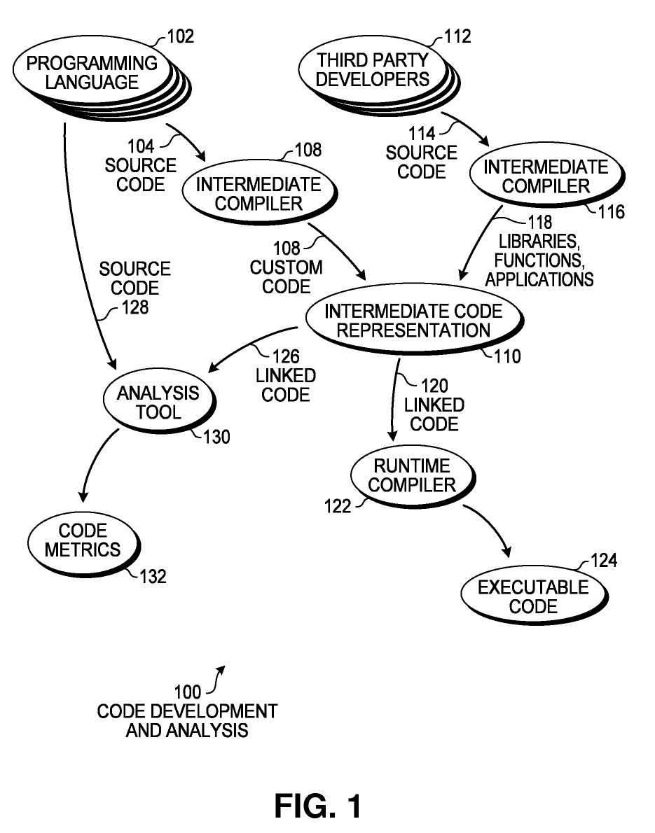

FIG. 1 is a diagram of an embodiment 100 showing the development and analysis of executable computer code. After developing and compiling source code into intermediate code, a complete application may be linked and analyzed to determine various metrics. The metrics may be used to determine a quantitative measure of maintainability, for example.

Code or software, as used in this specification, may be any type of computer instruction in any form. Various modifiers may be used to describe the development process for code. For example, source code may be a human readable code written in a computer language, such as C#, C++, FORTRAN, Visual Basic, Java, or any other computer language. Executable code may be the actual binary instruction set that is processed by a processor. Intermediate code is source code that has been compiled into an intermediate language, which may then be compiled into executable code or interpreted by a virtual machine. In many cases, intermediate code is linked and compiled at runtime.

Various programming languages 102 may be used to write source code 104 that is compiled by an intermediate compiler 106 that is used in a common language environment 110. Many different embodiments exist where two or more different computer languages 102 may be used to create intermediate representation 110. Generally, each source code language may have a unique compiler 106 that compiles the language into intermediate code language.

In some embodiments, a suite of languages 102 may be available to an application developer who wishes to develop an application that operates using the intermediate code representation 110. In some cases, a single user interface may be used to write software in a variety of languages, each language having an appropriate compiler that may generate intermediate code 110.

Intermediate code 110 may operate in a virtualized or runtime environment. Such an environment may be ported to different hardware platforms such that intermediate code may be used in any virtualized environment regardless of the hardware platform. Each hardware implementation may have a unique runtime compiler 122 that may perform the final compilation into executable code 124 that is specific to the hardware. Intermediate code in such an implementation may be hardware independent.

Third party developers 112 may also create source code 114 and, using an intermediate compiler 116, may create libraries, functions, and application 118 that may be available in intermediate code 110. The custom code 108 and third party code 118 may be combined to create an application.

In many instances, a software developer may develop some custom code 108 that refers to or links into code from other parties. In many cases, such third party code may be provided in compiled form and the source code 114 may not be available. By using intermediate code, the analysis tool 130 may evaluate a complete application without having to reference the source code 104 or 114. In this manner, very useful metrics may be simply and reliably created using the entirety of an application, even when source code is not available.

In some cases, the analysis tool 130 may reference source code 128, when available to create some of the code metrics 132.

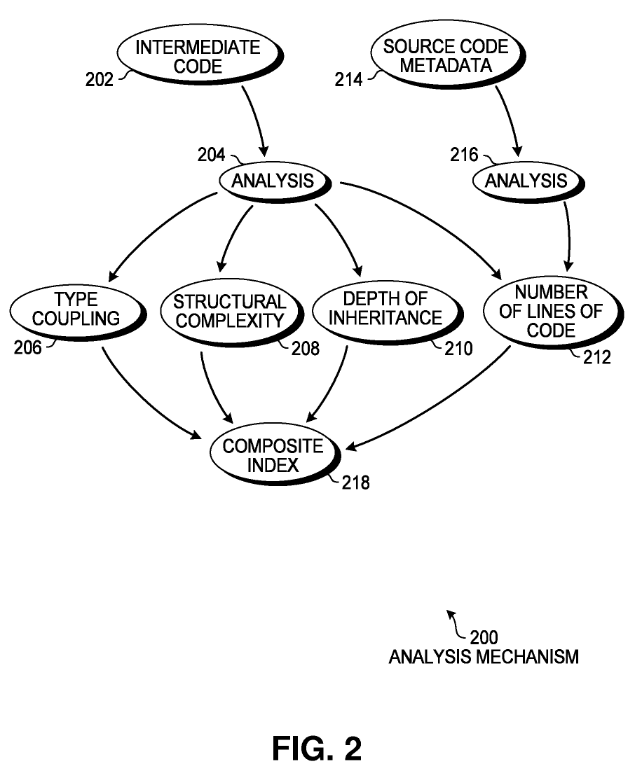

FIG. 2 is a diagram illustration of an embodiment 200 showing an analysis mechanism. The analysis generates various metrics from intermediate code and combines the metrics into a single index that can help identify poorly developed code from better code. In many instances, code that has a limited number of types, straight forward logic, a simplified inheritance structure, and a limited number of lines of code will be easier to understand and maintain. In many cases, such code may also be more reliable than more complex code.

Intermediate code 202 is analyzed by an analysis routine 204. The analysis routine 204 may perform several different analyses, including type coupling 206, cyclomatic complexity 208, depth of inheritance 210, and determining the number of lines of code 212. In some embodiments, the number of lines of code 212 may be determined from the intermediate code 202 while in other cases, source code metadata 214 may be analyzed 216 to determine the actual lines of code.

Type coupling analysis 206 may include determining the number of types in an object oriented programming language. When many different types are used in source code, especially abstract types, the code may be difficult to understand, making the code difficult to maintain. Types and members with a high degree of coupling can be more vulnerable to failure or have higher maintenance costs due to these inter-dependencies. In some embodiments, the number of different types may be counted as a statistic. Other embodiments may use different mechanisms for classifying or measuring the effects of types in source code.

For example, a severity ranking may be devised for type coupling where a low value may be assigned for segments of code that have fewer than 5 types, a medium value for code that has between 5 and 10 types, and a high value for code that has greater than 10 types. In other examples, the pure number of types may be returned as a statistic.

The results of a particular analysis may be a numerical value, such as the number of types, or may be a more qualitative value such as high, medium, or low severity. In some cases, a normalized value may be assigned, such as a ranking between 1 and 10 or a grade such as A, B, C, D, and F.

When an analysis is performed, the analysis may be performed on an entire application or a portion of code. For example, a developer may wish to determine metrics for a piece of code written by the developer. In another example, a project leader may wish to perform an analysis on an entire application to determine overall metrics for an application. In some cases, third party code may be included in an analysis while in other cases, third party code may be excluded.

Structural complexity 208 may be a measure of the cyclomatic complexity of logic of a program. Structural complexity may be determined by measuring the number of sequential groups of program statements (nodes) and program flows between nodes. In some embodiments, the number of branches may be counted. In other embodiments, different types of branches or conditional statements may be weighted higher or lower when calculating an overall metric. In still other embodiments, complex statistics may be generated in a report that details the structural complexity.

The depth of inheritance 210 may be calculated as the number of classes between an object and the root object in an object oriented programming language. Depth of inheritance may be calculated to account for multiple inheritance and/or the implementation of one or more interfaces. Because properties may be inherited to child classes, those classes with many layers of inheritance may be more difficult to understand and thus maintain. Changes to a high level object may cause many intended or unintended changes that may ripple through the inheritance chain.

The depth of inheritance 210 may be measured in many different ways. In a simplified analysis, a single value may be returned that is the maximum integer number of layers of inheritance for any object. In a more detailed analysis, a statistic may be generated that gave the average depth of inheritance for the objects in the worst twenty percent.

Other embodiments may use different mechanisms to describe the depth of inheritance or any other metric. In some embodiments, each metric may be reported as a single value, while in other embodiments, detailed statistics may be given in tabular form. Some reporting functions may include references to specific objects, types, or portions of code that are outside a predefined value or are within a certain percentage of the highest or lowest value.

The number of lines of code 212 may be calculated directly by using source code metadata 214 and performing an analysis 216 to render a value. In some cases, intermediate code 202 may be evaluated to determine an estimated number of lines of code. Typically, but not always, lines of code may refer to the number of lines of source code. The lines of code metric may comprise a literal line count or may be modified in order to eliminate whitespace, comments or other constructs from the metric.

When the intermediate code 202 is evaluated to determine an estimated number of lines of source code, the lines of intermediate code 202 may be counted and multiplied by a factor to determine an estimated number of lines of source code.

In some cases, the number of lines of code 212 may be used to calculate one or more of the other metrics. For example, structural complexity may be measured by the integer number of branches within a program divided by the number of lines of code. Similarly, type coupling or depth of inheritance may be similarly normalized by the number of lines of code to determine a value that may be compared across different code examples.

Various metrics may be combined to determine a composite index or metric 218. Different embodiments may calculate the index 218 in a different manner. Some embodiments may use the values from type coupling analysis 206, cyclomatic complexity analysis 208, depth of inheritance 210 and number of lines of code 212 to generate a value. Other embodiments may use a subset of such metrics while still other embodiments may use a superset.

The composite index 218 may be constructed and interpreted in several different manners. In some embodiments, the composite index 218 may be used as a maintainability index that describes the relative ease or difficulty in maintaining a portion of code. In other embodiment, the composite index 218 may be used as a quality index that describes the simplicity and elegance of a portion of code. Each embodiment may have different names for such an index, and the calculation of the index may be tailored for a particular emphasis.

The composite index 218 may be used to compare one portion of code with another. For example, two different software applications may be evaluated to compare which application may be more easily maintained. In another example, a software development group may have an internal standard that each application developed by the group may have a composite index below a maximum number.

When combining the various metrics into a composite index 218, each metric may be weighted in a different manner. The weights assigned to each metric may be a reflection of the relative importance of the metric to the composite index 218. For example, the number of lines of code may be an indication of the size of an application, but the cyclomatic complexity may have more to do with the difficulty a programmer may have in understanding and modifying the program at a later time.

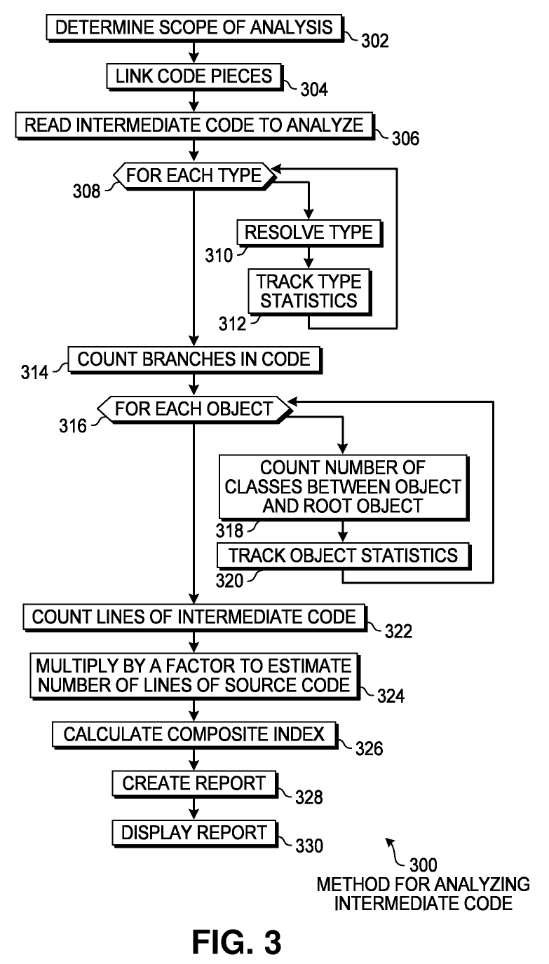

FIG. 3 is a flowchart illustration of an embodiment 300 showing a method for analyzing intermediate code. The embodiment 300 illustrates a simplified method for determining various statistics and combining the statistics into a single composite index.

The intermediate code may be linked in block 302. Intermediate code may come from various sources, including third party code, code written and compiled in different programming languages, and other sources. Linking assembles various objects into a single executable, which may join actual portions of code that may be executed.

The scope of the analysis is determined in block 304. In some cases, an entire application may be analyzed while in other cases, a portion of the available intermediate code may be analyzed. For example, a specific function or portion of code may be identified for analysis. In another example, a large application may be analyzed including libraries and functions that were supplied by third parties. In still another example, code may be analyzed except portions created by a third party.

For each type in block 308, the type is resolved in block 310. The type may be resolved through various portions of code, including third party code to which source code is not available. Because the intermediate code may be analyzed in a linked state, the type may be fully resolved.

Once the type is resolved in block 310, statistics may be maintained in block 312 to track the number and complexity of the types used in the code. In some embodiments, a complex set of statistics may be stored and analyzed, while in other embodiments, a single value of the number of different types may be updated.

The branches of code may be classified and counted in block 314. Different embodiments may have different methods for determining the cyclomatic complexity of a portion of code. A simple version may use an integer number of code branches for cyclomatic complexity while other versions may use a weighted analysis that takes into account the complexity or severity of the branches of code.

For each object in block 316, the number of classes between the object and the root object may be determined. Statistics relating to the inheritance between classes of objects may be kept in block 320.

In some embodiments, an integer number of the levels of classes between an object and the root object may be counted. A statistic may be kept representing the maximum number of layers found in the objects. Other statistics may include the total number of children of any level for an object or some other measure of the amount of inherited properties that are used in a portion of code. As with other metrics, some analyses may include complex statistics, summaries, and other data. In some cases, tables of objects may be created that represent the worst cases found in the analysis.

The number of lines of intermediate code is counted in block 322 and multiplied by a factor to give an estimated number of lines of source code in block 324. In some embodiments, source code metadata or the source code itself may be analyzed to determine an actual number of lines of source code.

The various factors may be used to calculate a composite index in block 326. Each embodiment may use a different formula that may include weighting factors for each metric used in calculating a composite index. Some embodiments may use a subset of metrics while other embodiments may use additional metrics to determine a composite index.

Each embodiment may have a composite index that gives a relative value that can be compared to other pieces of code. In some cases, the composite index may be a numerical quantity. In other cases, the composite index may be a qualitative value such as good, acceptable, or bad. In other cases, the index might be expressed as a visual element, such as a red, green or yellow indicator.

A report may be generated in block 328 and displayed in block 330. Each embodiment may have a different level of detail, output format, or other factors that make up a report. Similarly, the display may be performed in any manner.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
reading intermediate language computer code;
finding a plurality of type definitions in said intermediate language computer code;
for each of said plurality of type definitions, resolving said type definition in said intermediate language computer code; and
determining a number of different types used in said intermediate language computer code.

2. The method of claim 1, said intermediate language code comprising code compiled from two different languages.

3. The method of claim 1, said intermediate language code comprising linked code.

4. The method of claim 1 further comprising:
determining structural complexity.

5. The method of claim 1 further comprising:
determining lines of code.

6. The method of claim 5, said determining lines of code comprising evaluating source code metadata.

7. The method of claim 5, said determining lines of code comprising:
determining a line count from said intermediate code; and
multiplying said line count by a factor to determine said lines of code.

8. The method of claim 1 further comprising:
determining depth of inheritance.

9. The method of claim 1 further comprising:
determining a composite index based on said number of different types.

10. A computer readable medium comprising computer executable instructions adapted to perform the method of claim 1.

11. A system comprising:
a reader adapted to read intermediate language computer code; and
an analyzer adapted to resolve at least one type in said intermediate language computer code to determine a type coupling, said type coupling comprising a number of different types.

12. The system of claim 11, said analyzer further adapted to perform at least one of a group composed of:
determine a structural complexity for said intermediate language computer code;
determine a lines of code value for said intermediate language computer code;
determine a depth of inheritance for said intermediate language computer code; and
determine a composite index comprising at least said type coupling.

13. The system of claim 11 further comprising:
a linker adapted to link said intermediate language computer code.

14. A method comprising:
reading an intermediate language computer code;
linking said intermediate language computer code; and
calculating a composite index from said intermediate language computer code.

15. The method of claim 14 further comprising:
reading metadata about source code used to derive said intermediate language computer code.

16. The method of claim 14, said maintainability index being further calculated from said metadata.

17. The method of claim 14 further comprising:
finding a plurality of type definitions in said intermediate language computer code; and
for each of said plurality of type definitions, resolving said type definition.

18. The method of claim 14 further comprising at least one of a group composed of:
determining a structural complexity for said intermediate language computer code;
determining a lines of code value for said intermediate language computer code; and
determining a depth of inheritance for said intermediate language computer code.

19. The method of claim 14, said composite index being calculated from at least one of a group composed of:
a structural complexity for said intermediate language computer code;
a lines of code value for said intermediate language computer code; and
a depth of inheritance for said intermediate language computer code.

20. A computer readable medium comprising computer executable instructions adapted to perform the method of claim 14.
